(19) United States
(12) Patent Application Publication
(10) Pub. No.: US 2018/0269008 A1
(43) Pub. Date: Sep. 20, 2018

(54) METHOD OF MANUFACTURING CARBON SHEET

(71) Applicant: HONDA MOTOR CO., LTD., Tokyo (JP)

(72) Inventors: Yusuke Kawaguchi, Tochigi (JP); Toshiaki Shimizu, Tochigi (JP); Toyokazu Kumazawa, Tochigi (JP); Satoshi Oyama, Tochigi (JP); Hiromu Kobori, Tochigi (JP); Keisuke Ota, Tochigi (JP); Shinpei Teshima, Tochigi (JP); Kentaro Matsunaga, Tochigi (JP)

(21) Appl. No.: 15/920,707

(22) Filed: Mar. 14, 2018

(30) Foreign Application Priority Data
Mar. 17, 2017 (JP) 2017-052467

(51) Int. Cl. H01G 11/86; H01G 11/38

(52) U.S. Cl. CPC H01G 11/86; H01G 11/38

(57) ABSTRACT

To transfer slurry without a binder smoothly in each transition between a dewatering process, a water squeezing process, and a drying process during formation of the slurry into a sheet-like shape through these processes. A dewatering process unit P1 conveys slurry while removing moisture in the slurry. A water squeezing process unit P2 conveys the resultant slurry while squeezing water from the slurry by rolling the slurry. A drying process unit P3 conveys the resultant slurry while drying the slurry by heating the slurry. The conveyance speed of the slurry in the water squeezing process is lower than the conveyance speed of the slurry in the dewatering process. The conveyance speed of the slurry in the drying process is lower than the conveyance speed of the slurry in the water squeezing process. A first speed difference showing a difference between the conveyance speed of the slurry in the dewatering process and the conveyance speed of the slurry in the water squeezing process is smaller than a second speed difference showing a difference between the conveyance speed of the slurry in the water squeezing process and the conveyance speed of the slurry in the drying process.

### METHOD OF MANUFACTURING CARBON SHEET

This application is based on and claims the benefit of priority from Japanese Patent Application No. 2017-052467, filed on 17 Mar. 2017, the content of which is incorporated herein by reference.

### BACKGROUND OF THE INVENTION

### Field of the Invention

The present invention relates to a method of manufacturing a carbon sheet used for a polarizing electrode of an electrical double-layer capacitor, for example.

### Related Art

There has conventionally been a carbon sheet of this type formed by preparing slurry by dispersing a carbon nanotube, nano-carbon particles, and a binder in water, dewatering the slurry, and forming the slurry into a sheet-like shape. For mass production of such carbon sheets, a manufacturing method as follows may be employed by following a common paper making technique. First, moisture in the slurry is caused to drop under the weight of the slurry through holes in a wire mesh (dewatering process). Next, the slurry is rolled with a pair of rollers to form the slurry into a sheet-like shape (water squeezing process). Then, the slurry is heated with a hot roller to evaporate moisture (drying process). A phenomenon of expansion of the slurry containing the binder resulting from reduction in moisture content is observed during the manufacture. Hence, effort has been made to prevent the occurrence of a sag in the slurry during transfer of the slurry in each transition between the processes (dewatering process, water squeezing process, and drying process) by increasing the conveyance speed of the slurry stepwise after implementation of each of these processes.

A carbon fiber film without a binder has been suggested (see Patent Document 1, for example). This carbon fiber film is obtained by preparing slurry containing only a carbon nanotube and a carbon material other than the carbon nanotube (graphene, graphite, or carbon black, for example), specifically, slurry without a binder for the carbon nanotube and such a carbon material, filtering the slurry under reduced pressure, and then drying the slurry. This carbon fiber film has the advantage of reducing manufacturing costs and increasing electric capacity per mass achieved by replacing part of the costly carbon nanotube by the inexpensive carbon material and omitting a binder without conductivity.

There is a disclosed technique relating to a method of manufacturing a graphite sheet (see Patent Document 2, for example). According to this technique, for the purpose of preventing the occurrence of a crease, the graphite sheet is pulled at a position where the graphite sheet is to be inserted into a rolling roller toward a direction opposite the direction of the insertion to remove the unevenness of the graphite sheet, and then the graphite sheet is inserted into the rolling roller.

Patent Document 1: PCT International Publication No. WO2015/072370

Patent Document 2: Japanese Unexamined Patent Application, Publication No. 2000-16808

### SUMMARY OF THE INVENTION

Contrary to the presence of a binder, the absence of a binder (Patent Document 1) causes a phenomenon of shrinkage of the slurry resulting from reduction in moisture content in the slurry. Hence, conveying the slurry at the same speed in the three processes entirely including the dewatering process, the water squeezing process, and the drying process, or even increasing the conveyance speed of the slurry after implementation of each process causes the risk of pulling the slurry excessively in the direction of the conveyance and cutting the slurry. This disables smooth transfer of the slurry in each transition between the processes due to cutting of the slurry.

Patent Document 2 pays no attention in the first place to the phenomenon of shrinkage of slurry without a binder resulting from reduction in moisture content in the slurry.

In view of the foregoing circumstances, the present invention is intended to provide a method of manufacturing a carbon sheet allowing smooth transfer of slurry without a binder in each transition between a dewatering process, a water squeezing process, and a drying process during formation of the slurry into a sheet-like shape through these processes.

A method of manufacturing a carbon sheet according to the present invention is a method of manufacturing a carbon sheet by forming slurry containing a carbon nanotube, nano-carbon particles, and water into a sheet-like shape. The method comprises: a dewatering process of conveying the slurry while removing moisture in the slurry; a water squeezing process of conveying the slurry having been subjected to the dewatering process while squeezing water from the slurry by rolling the slurry; and a drying process of conveying the slurry having been subjected to the water squeezing process while drying the slurry by heating the slurry. The dewatering process, the water squeezing process, and the drying process are performed in this order. Among the dewatering process, the water squeezing process, and the drying process, the conveyance speed of the slurry in a subsequent process is lower than the conveyance speed of the slurry in a preceding process.

The water squeezing process may be divided into multiple processes, and among the multiple divided processes, the conveyance speed of the slurry in the subsequent process may be lower than the conveyance speed of the slurry in the preceding process.

The conveyance speed of the slurry in the preceding process and the conveyance speed of the slurry in the subsequent process may differ from each other at two points or more, speed differences at any two of these points may be determined to be an upstream speed difference and a downstream speed difference viewed from an upstream side, and the upstream speed difference may be smaller than the downstream speed difference.

A first speed difference (first speed difference ΔVS1 described later, for example) showing a difference between the conveyance speed (conveyance speed VS1 described later, for example) of the slurry in the dewatering process and the conveyance speed (conveyance speed VS2 described later, for example) of the slurry in the water squeezing process may be smaller than a second speed difference (second speed difference ΔVS2 described later, for example) showing a difference between the conveyance speed of the slurry in the water squeezing process and the conveyance speed (conveyance speed VS3 described later, for example) of the slurry in the drying process.

The method of manufacturing a carbon sheet provided by the present invention allows smooth transfer of slurry without a binder in each transition between a dewatering process, a water squeezing process, and a drying process during formation of the slurry into a sheet-like shape through these processes.

### BRIEF DESCRIPTION OF THE DRAWINGS

FIG. 1 is a front view showing a device for manufacturing a carbon sheet in outline according to a first embodiment of the present invention; and

FIG. 2 is a graph showing a relationship between moisture content in slurry and the amount of shrinkage of the slurry.

### DETAILED DESCRIPTION OF THE INVENTION

A first embodiment of the present invention will be described below based on the drawings.

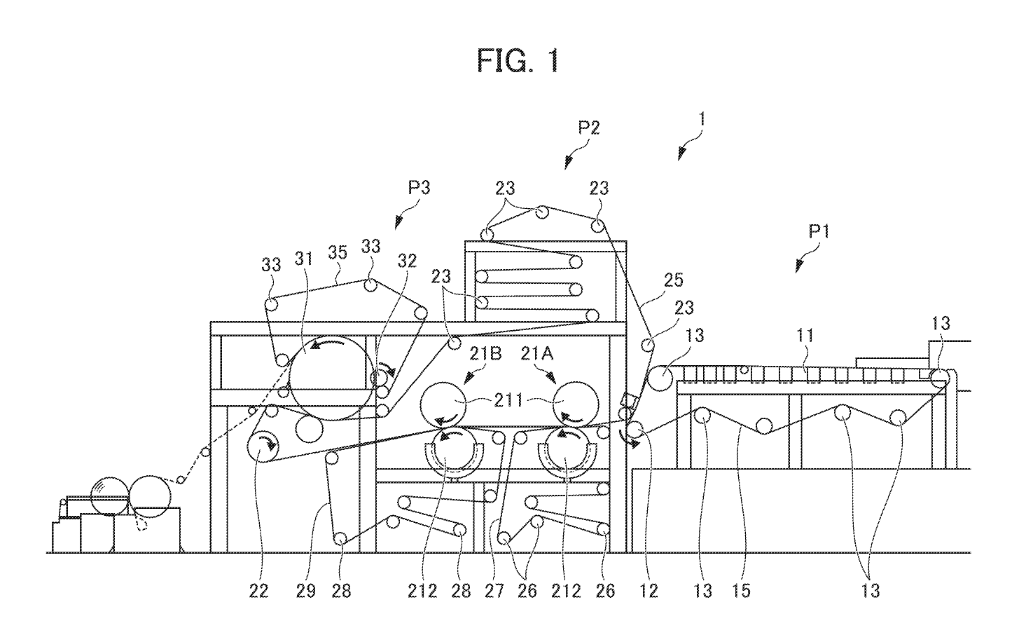

FIG. 1 is a front view showing a device for manufacturing a carbon sheet in outline according to the first embodiment of the present invention.

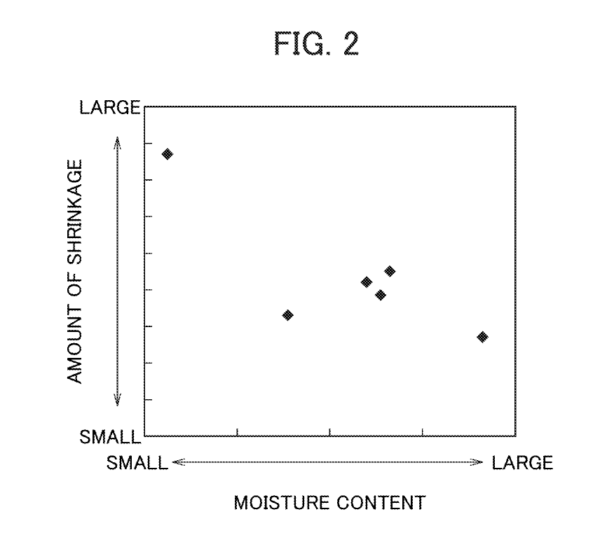

FIG. 2 is a graph showing a relationship between moisture content in slurry and the amount of shrinkage of the slurry.

As shown in FIG. 1, a device 1 for manufacturing a carbon sheet according to the first embodiment is a conveyor-type device including a dewatering process unit P1, a water squeezing process unit P2, and a drying process unit P3.

The dewatering process unit P1 is responsible for a dewatering process of conveying (carrying) slurry in a leftward direction (toward the water squeezing process unit P2) of FIG. 1 while removing moisture in the slurry. The dewatering process unit P1 has a horizontal wire mesh 11 with predetermined apertures. A driving wheel 12 and multiple idler wheels 13 are arranged near (mainly, below) the wire mesh 11. Further, an endless belt 15 is stretched over the driving wheel 12 and the multiple idler wheels 13. The endless belt 15 is configured to pass above the wire mesh 11 in the leftward direction of FIG. 1 in response to rotation of the driving wheel 12.

The water squeezing process unit P2 is responsible for a water squeezing process of conveying the slurry in the leftward direction (toward the drying process unit P3) of FIG. 1 having been conveyed from the dewatering process unit P1 while squeezing water from the slurry by rolling the slurry. The water squeezing process unit P2 includes two rollers 21A and 21B. Each of the rollers 21A and 21B includes an idler roll 211 and a driving roll 212 vertically arranged as a pair. All the two idler rolls 211 and the two driving rolls 212 have the same diameter.

A driving wheel 22 and multiple idler wheels 23 are arranged near (mainly, above) the two rollers 21A and 21B. Further, a first endless belt 25 made from a felt member is stretched over the driving wheel 22 and the multiple idler wheels 23. The first endless belt 25 is configured to pass between the idler roll 211 and the driving roll 212 of each of the rollers 21A and 21B in the leftward direction of FIG. 1 in response to rotation of the driving wheel 22.

Multiple idler wheels 26 are arranged near (mainly below) the roller 21A. Further, a second endless belt 27 made from a felt member is stretched over the multiple idler wheels 26. The second endless belt 27 is configured to pass between the idler roll 211 and the driving roll 212 of the roller 21A in the leftward direction of FIG. 1 in response to rotation of the driving roll 212 of the roller 21A.

Multiple idler wheels 28 are arranged near (mainly below) the roller 21B. Further, a third endless belt 29 made from a felt member is stretched over the multiple idler wheels 28.

The third endless belt 29 is configured to pass between the idler roll 211 and the driving roll 212 of the roller 21B in the leftward direction of FIG. 1 in response to rotation of the driving roll 212 of the roller 21B.

The drying process unit P3 is responsible for a drying process of conveying the slurry in the leftward direction of FIG. 1 having been conveyed from the water squeezing process unit P2 while drying the slurry by heating the slurry. The drying process unit P3 includes a hot roller 31. A driving wheel 32 and multiple idler wheels 33 are arranged near (mainly, above) the hot roller 31. Further, an endless belt 35 is stretched over the driving wheel 32 and the multiple idler wheels 33. The driving wheel 32 contacts the hot roller 31 through the endless belt 35. The hot roller 31 is configured to rotate anticlockwise in response to rotation of the driving wheel 32. Further, the endless belt 35 is configured to move anticlockwise along an upper part of the circumference of the hot roller 31 in synchronization with the hot roller 31 in response to rotation of the driving wheel 32.

The device 1 for manufacturing a carbon fiber includes a built-in controller not shown in the drawings. This controller exerts control so as to rotate the driving wheel 12 in the dewatering process unit P1, the driving wheel 22 and the respective driving rolls 212 of the two rollers 21A and 21B in the water squeezing process unit P2, and the driving wheel 32 in the drying process unit P3.

The following procedure is followed for manufacturing a carbon sheet without a binder using the device 1 having the foregoing configuration for manufacturing the carbon sheet.

First, in a slurry preparation process, slurry containing a carbon nanotube, furnace black (nano-carbon particles), and water is prepared. As shown in FIG. 2, an experiment conducted to examine influence over the amount of shrinkage of the slurry by moisture content in this slurry shows that there is a negative correlation between moisture content in the slurry and the amount of shrinkage of the slurry. Reduction in moisture content in the slurry is found to develop tendency to increase the amount of shrinkage of the slurry. In the graph of FIG. 2, a horizontal axis shows a moisture content in the slurry (unit: %) and a vertical axis shows the amount of shrinkage of the slurry (unit: mm).

The slurry without a binder is considered to shrink for the following reason. The van der Waals force (about 1 kJ/mol) is an interaction weaker than hydrogen bonds (10 to 40 kJ/mol). Meanwhile, the van der Waals force acting on the specific surface areas of the carbon nanotube and the furnace black (about 1000 m²/g) is stronger than the force of hydrogen bonds acting on cellulose. Thus, in comparison to cellulose as a principal component of paper, the slurry without a binder is considered to shrink.

Next, a transition is made to a conveyor driving process and the driving wheel 12 in the dewatering process unit P1 is rotated. Then, the endless belt 15 in the dewatering process unit P1 moves so as to pass above the wire mesh 11 in the leftward direction of FIG. 1. At this time, based on the fact that the circumferential speed of the driving wheel 12 is proportionate to the diameter of the driving wheel 12, the rotation speed of the driving wheel 12 is set in order to move the endless belt 15 at predetermined movement speed VB1.

Further, the driving wheel 22 in the water squeezing process unit P2 is rotated. Then, the first endless belt 25 in the water squeezing process unit P2 moves so as to pass between the idler roll 211 and the driving roll 212 of each of the two rollers 21A and 21B in the leftward direction of FIG. 1. At this time, based on the fact that the circumferential speed of the driving wheel 22 is proportionate to the diameter of the driving wheel 22, the rotation speed of the driving wheel 22 is set in order to move the first endless belt 25 at predetermined movement speed VB2. The movement speed VB2 of the first endless belt 25 is lower than the movement speed VB1 of the endless belt 15 described above (VB2<VB1).

The driving roll 212 of the roller 21A in the water squeezing process unit P2 is also rotated. Then, the second endless belt 27 in the water squeezing process unit P2 moves so as to pass between the idler roll 211 and the driving roll 212 of the roller 21A in the leftward direction of FIG. 1. At this time, based on the fact that the circumferential speed of the driving roll 212 of the roller 21A is proportionate to the diameter of the driving roll 212 of the roller 21A, the rotation speed of the driving roll 212 of the roller 21A is set in order to move the second endless belt 27 at movement speed VB3 same as the movement speed VB2 of the first endless belt 25.

The driving roll 212 of the roller 21B in the water squeezing process unit P2 is also rotated. Then, the third endless belt 29 in the water squeezing process unit P2 moves so as to pass between the idler roll 211 and the driving roll 212 of the roller 21B in the leftward direction of FIG. 1. At this time, based on the fact that the circumferential speed of the driving roll 212 of the roller 21B is proportionate to the diameter of the driving roll 212 of the roller 21B, the rotation speed of the driving roll 212 of the roller 21B is set in order to move the third endless belt 29 at movement speed VB4 same as the movement speed VB2 of the first endless belt 25.

Further, the driving wheel 32 in the drying process unit P3 is rotated. Then, the hot roller 31 in the drying process unit P3 rotates anticlockwise and the endless belt 35 in the drying process unit P3 moves anticlockwise along an upper part of the circumference of the hot roller 31 in synchronization with the hot roller 31. At this time, based on the fact that the circumferential speed of the driving wheel 32 is proportionate to the diameter of the driving wheel 32, the rotation speed of the driving wheel 32 is set in order to move the endless belt 35 at predetermined movement speed VBS. The movement speed VB5 of the endless belt 35 is lower than the movement speed VB2 of the first endless belt 25 described above (VB5<VB2). Further, a first speed difference ΔVB1 (=VB1−VB2) showing a difference between the movement speed VB1 of the endless belt 15 and the movement speed VB2 of the first endless belt 25 is smaller than a second speed difference ΔVB2 (=VB2−VB5) showing a difference between the movement speed VB2 of the first endless belt 25 and the movement speed VB5 of the endless belt 35 (ΔVB1<ΔVB2).

In this state, the aforementioned slurry is carried onto the endless belt 15 in the dewatering process unit P1. Then, in the dewatering process unit P1, the slurry is conveyed at the same speed as the endless belt 15, specifically, at the predetermined speed VB1 in the leftward direction of FIG. 1 while being placed on the endless belt 15. At this time, moisture in the slurry is caused to drop under the weight of the slurry through the wire mesh 11, so that the slurry is dewatered to reduce moisture content in the slurry. Next, the slurry is transferred from the dewatering process unit P1 to the water squeezing process unit P2.

In the water squeezing process unit P2, the slurry is rolled with the roller 21A while being caught between the first endless belt 25 and the second endless belt 27. Then, the slurry is rolled with the roller 21B while being caught between the first endless belt 25 and the third endless belt 29. At the same time, the slurry is conveyed at the same speed as the three endless belts 25, 27, and 29, specifically, at the predetermined speed VB2 in the leftward direction of FIG. 1. At this time, moisture is removed from the slurry as a result of rolling with the roller 21A and water absorption by the felt members forming the endless belts 25, 27, and 29. Thus, moisture content in the slurry is reduced further to form the slurry into a substantially sheet-like shape. Next, the slurry is transferred from the water squeezing process unit P2 to the drying process unit P3. As described above, the respective movement speeds VB2, VB3, and VB4 of the three endless belts 25, 27, and 29 in the water squeezing process unit P2 are lower than the movement speed VB1 of the endless belt 15 in the dewatering process unit P1. Thus, conveyance speed VS2 of the slurry in the water squeezing process is lower than conveyance speed VS1 of the slurry in the dewatering process (VS2<VS1).

In the drying process unit P3, the slurry is conveyed along the circumference of the hot roller 31 anticlockwise at the same speed as the movement speed VB5 of the endless belt 35 in the leftward direction of FIG. 1. At this time, the slurry is heated and dried with the hot roller 31. Thus, moisture content in the slurry is reduced further to form the slurry into a sheet-like shape. Then, the slurry is carried out of the drying process unit P3. As described above, the movement speed VB5 of the endless belt 35 in the drying process unit P3 is lower than the respective movement speeds VB2, VB3, and VB4 of the three endless belts 25, 27, and 29 in the water squeezing process unit P2. Thus, conveyance speed VS3 of the slurry in the drying process is lower than the conveyance speed VS2 of the slurry in the water squeezing process (VS3<VS2).

As described above, the first speed difference ΔVB1 showing a difference between the movement speed VB1 of the endless belt 15 and the movement speed VB2 of the first endless belt 25 is smaller than the second speed difference ΔVB2 showing a difference between the movement speed VB2 of the first endless belt 25 and the movement speed VB5 of the endless belt 35. This makes a first speed difference ΔVS1 showing a difference between the conveyance speed VS1 of the slurry in the dewatering process and the conveyance speed VS2 of the slurry in the water squeezing process smaller than a second speed difference ΔVS2 showing a difference between the conveyance speed VS2 of the slurry in the water squeezing process and the conveyance speed VS3 of the slurry in the drying process (ΔVS1<ΔVS2).

In this way, the carbon sheet without a binder is obtained to finish manufacture of the carbon sheet.

As described above, for manufacturing the carbon sheet without a binder, the conveyance speeds VS1, VS2, and VS3 of the slurry are reduced stepwise. Specifically, when the slurry is transferred from the dewatering process unit P1 to the water squeezing process unit P2, the conveyance speed of the slurry is reduced. Further, when the slurry is transferred from the water squeezing process unit P2 to the drying process unit P3, the conveyance speed of the slurry is reduced further. As a result, during formation of the slurry without a binder into a sheet-like shape through the dewatering process, the water squeezing process, and the drying process, the slurry can be transferred smoothly in each transition between the processes (dewatering process, water squeezing process, and drying process) in response to the phenomenon of shrinkage of the slurry resulting from reduction in moisture content in the slurry. This achieves mass production of carbon sheets.

Additionally, the value of reduction in conveyance speed of the slurry during transfer of the slurry from the water squeezing process unit P2 to the drying process unit P3 (specifically, the second speed difference ΔVS2) is larger than the value of reduction in conveyance speed of the slurry during transfer of the slurry from the dewatering process unit P1 to the water squeezing process unit P2 (specifically, the first speed difference ΔVS1). This achieves more smooth transfer of the slurry in each transition between the processes if reduction in moisture content in the slurry develops tendency to increase the amount of shrinkage of the slurry.

The present invention is not limited to the above-described embodiment. The effects described in the embodiment are merely a list of most preferred effects resulting from the present invention. Effects achieved by the present invention are not limited to those described in the embodiment.

In the foregoing first embodiment, for example, the conveyance speed VS2 of the slurry in the water squeezing process is lower than the conveyance speed VS1 of the slurry in the dewatering process, and the conveyance speed VS3 of the slurry in the drying process is lower than the conveyance speed VS2 of the slurry in the water squeezing process (VS3<VS2<VS1). However, this is not the only case but only the conveyance speed VS2 of the slurry in the water squeezing process may be lower than the conveyance speed VS1 of the slurry in the dewatering process (VS2<VS1). Alternatively, only the conveyance speed VS3 of the slurry in the drying process may be lower than the conveyance speed VS2 of the slurry in the water squeezing process (VS3<VS2).

Specifically, among the dewatering process, the water squeezing process, and the drying process, it is required only to set the conveyance speed of the slurry in a subsequent process to be lower than the conveyance speed of the slurry in a preceding process. If multiple processes are to be performed continuously, the preceding process and the subsequent process are determined based on the order of performing the preceding process and the order of performing the subsequent process. For example, if the conveyance speed VS2 of the slurry in the water squeezing process is set to be lower than the conveyance speed VS1 of the slurry in the dewatering process, the dewatering process to be performed earlier corresponds to the preceding process and the water squeezing process to be performed later corresponds to the subsequent process. Further, if the conveyance speed VS3 of the slurry in the drying process is set to be lower than the conveyance speed VS2 of the slurry in the water squeezing process, the water squeezing process to be performed earlier corresponds to the preceding process and the drying process to be performed later corresponds to the subsequent process.

In the foregoing first embodiment, for manufacturing the carbon sheet by following the dewatering process, the water squeezing process, and the drying process in this order, the conveyance speed of the slurry is constant in the water squeezing process. Meanwhile, the water squeezing process is a significant process for adjusting moisture content in the slurry. Thus, it is highly desirable that the conveyance speed of the slurry be adjusted stepwise further within the water squeezing process. To satisfy this desire, the water squeezing process may be divided into multiple processes. Among these processes, the conveyance speed of the slurry in a subsequent process may be set to be lower than the conveyance speed of the slurry in a preceding process. Also in this case, if the multiple processes are to be performed continuously, the preceding process and the subsequent process are determined based on the order of performing the preceding process and the order of performing the subsequent process. This is applicable not only to the water squeezing process but is also applicable in the same way to the dewatering process and the drying process.

In the foregoing first embodiment, for manufacturing the carbon sheet by following the dewatering process, the water squeezing process, and the drying process in this order, an upstream speed difference, specifically, the value of reduction in conveyance speed of the slurry during transfer of the slurry from the dewatering process unit P1 to the water squeezing process unit P2 (first speed difference ΔVS1), is set to be smaller than a downstream speed difference, specifically, the value of reduction in conveyance speed of the slurry during transfer of the slurry from the water squeezing process unit P2 to the drying process unit P3 (second speed difference ΔVS2) (ΔVS1<ΔVS2).

Meanwhile, it is assumed that one or more of the dewatering process, the water squeezing process, and the drying process are divided into multiple processes, and the conveyance speed of the slurry in a preceding process and the conveyance speed of the slurry in a subsequent process differ from each other at two points or more. Speed differences at any two of these points are determined to be an upstream speed difference and a downstream speed difference viewed from an upstream side. In this case, the upstream speed difference can be set to be smaller than the downstream speed difference. Also in this case, if multiple processes are to be performed continuously, the preceding process and the subsequent process are determined based on the order of performing the preceding process and the order of performing the subsequent process. In this way, the upstream speed difference can be set to be smaller than the downstream speed difference not only in the presence of a difference in conveyance speed of the slurry between the dewatering process and the water squeezing process and between the water squeezing process and the drying process but also in the presence of a difference in conveyance speed of the slurry between multiple divided processes in the water squeezing process.

### EXPLANATION OF REFERENCE NUMERALS

1 . . . Device for manufacturing carbon sheet
P1 . . . Dewatering process unit
P2 . . . Water squeezing process unit
P3 . . . Drying process unit
VS1 . . . Conveyance speed of slurry in dewatering process
VS2 . . . Conveyance speed of slurry in water squeezing process
VS3 . . . Conveyance speed of slurry in drying process
ΔVS1 . . . First speed difference
ΔVS2 . . . Second speed difference

What is claimed is:

1. A method of manufacturing a carbon sheet by forming slurry containing a carbon nanotube, nano-carbon particles, and water into a sheet-like shape, the method comprising:
a dewatering process of conveying the slurry while removing moisture in the slurry;
a water squeezing process of conveying the slurry having been subjected to the dewatering process while squeezing water from the slurry by rolling the slurry; and
a drying process of conveying the slurry having been subjected to the water squeezing process while drying the slurry by heating the slurry, the dewatering process, the water squeezing process, and the drying process being performed in this order, wherein
among the dewatering process, the water squeezing process, and the drying process, the conveyance speed of the slurry in a subsequent process is lower than the conveyance speed of the slurry in a preceding process.

2. The method of manufacturing a carbon sheet according to claim 1, wherein the water squeezing process is divided into multiple processes, and among the multiple divided processes, the conveyance speed of the slurry in a subsequent process is lower than the conveyance speed of the slurry in a preceding process.

3. The method of manufacturing a carbon sheet according to claim 1, wherein the conveyance speed of the slurry in the preceding process and the conveyance speed of the slurry in the subsequent process differ from each other at two points or more, speed differences at any two of these points are determined to be an upstream speed difference and a downstream speed difference viewed from an upstream side, and the upstream speed difference is smaller than the downstream speed difference.

4. The method of manufacturing a carbon sheet according to claim 2, wherein the conveyance speed of the slurry in the preceding process and the conveyance speed of the slurry in the subsequent process differ from each other at two points or more, speed differences at any two of these points are determined to be an upstream speed difference and a downstream speed difference viewed from an upstream side, and the upstream speed difference is smaller than the downstream speed difference.

5. The method of manufacturing a carbon sheet according to claim 1, wherein a first speed difference showing a difference between the conveyance speed of the slurry in the dewatering process and the conveyance speed of the slurry in the water squeezing process is smaller than a second speed difference showing a difference between the conveyance speed of the slurry in the water squeezing process and the conveyance speed of the slurry in the drying process.

6. The method of manufacturing a carbon sheet according to claim 2, wherein a first speed difference showing a difference between the conveyance speed of the slurry in the dewatering process and the conveyance speed of the slurry in the water squeezing process is smaller than a second speed difference showing a difference between the conveyance speed of the slurry in the water squeezing process and the conveyance speed of the slurry in the drying process.

7. The method of manufacturing a carbon sheet according to claim 3, wherein a first speed difference showing a difference between the conveyance speed of the slurry in the dewatering process and the conveyance speed of the slurry in the water squeezing process is smaller than a second speed difference showing a difference between the conveyance speed of the slurry in the water squeezing process and the conveyance speed of the slurry in the drying process.

8. The method of manufacturing a carbon sheet according to claim 4, wherein a first speed difference showing a difference between the conveyance speed of the slurry in the dewatering process and the conveyance speed of the slurry in the water squeezing process is smaller than a second speed difference showing a difference between the conveyance speed of the slurry in the water squeezing process and the conveyance speed of the slurry in the drying process.
